(19) United States
(12) Patent Application Publication
(10) Pub. No.: US 2013/0288221 A1
(43) Pub. Date: Oct. 31, 2013

(54) COMPUTING DEVICE-BASED EDUCATIONAL CONTENT DELIVERY SYSTEM

(71) Applicant: The University of Western Ontario, London (CA)

(72) Inventor: Suzanne Kearns, Kitchener (CA)

(21) Appl. No.: 13/864,635

(22) Filed: Apr. 17, 2013

Related U.S. Application Data
(60) Provisional application No. 61/625,389, filed on Apr. 17, 2012.

(51) Int. Cl. G09B 7/00

(52) U.S. Cl. CPC G09B 7/00
USPC 434/362

(57) ABSTRACT

Systems, methods, and devices relating to the delivery of educational content to a user's computing device. An application for use with mobile computing devices or with computers is first downloaded by a user. Data related to a complete educational course is downloaded and installed on the user's computing device. When launched, the application provides the user with the educational content using voice enabled avatars. The educational content is designed to last up to 15 minutes to be delivered to the user.

### TECHNICAL FIELD

The present invention relates to educational training. More specifically, the present invention relates to educational content and testing delivered by way of specific application software for use by various computing devices.

### BACKGROUND OF THE INVENTION

The data processing and communications revolution of the late 20th and early 21st century has permeated most aspects of modern life. Computers and communications devices are everywhere and have been adapted for use in everything from shopping to managing home appliances to cooking. In the field of education, computers and computing devices are almost ubiquitous—students use tablets, smartphones, and laptops for everything from research to taking tests to submitting assignments.

One shortcoming that, so far, has not been addressed is the time factor for learning. Formalized, classroom-setting instruction is useful for teaching students new skills while formalized testing and assessment of these new skills do well in determining if the students have learned these skills. However, these traditional frameworks for learning can take significant amounts of time for the student. Adult students, especially those with burgeoning careers and/or family lives, usually do not have such time to spare for skills upgrading courses.

Self-directed or self-paced learning with targeted source material may assist the busy adult in learning and upgrading skills. However, again, the student has to dedicate significant blocks of time, usually in the order of at least a few uninterrupted hours of study, for such an activity. Finding these blocks of time can be quite a challenge for busy people.

While such blocks of time may be difficult to find, it should be noted that small blocks of time for which a busy person is free, usually in the order of 10-15 minutes or less, can usually be found at various times of the day. Currently, there are no educational or testing systems which take advantage of these smaller but useful blocks of time.

In addition to the above, it is important to note that learners forget information very quickly after leaving a classroom, as much as 80% after only one week. That being said, it has been found that people remember more material if the content has been distributed over time (such as several weeks) rather than in one sitting.

Based on the above, there is therefore a need for systems, methods, or devices which mitigate if not overcome the shortcomings of the prior art.

### SUMMARY OF INVENTION

The present invention provides systems, methods, and devices relating to the delivery of educational content to a user's computing device. An application for use with mobile computing devices or with computers is first downloaded by a user. Data related to a complete educational course is downloaded and installed on the user's computing device. When launched, the application provides the user with the educational content using voice enabled avatars. The educational content is designed to last up to 15 minutes to be delivered to the user. Once the educational content has been delivered, the user can take a test that assesses the user's knowledge and retention of the educational content delivered to the user. The test may be time limited and the questions are randomly selected from a database of questions relating to the educational content. Once the test has been completed, the results are used to modify the user's profile on a server. The user's profile tracks the user's progress in completing a number of different courses or groups of courses.

In a first aspect, the present invention provides a system for providing educational content to students, the system comprising:
a first database containing data relating to said education content, said data including voice data;
a second database containing user information;
computer readable media having encoded thereon computer readable and computer executable instructions which, when executed by a processor, implements a method for delivering said educational content to users, the method comprising:
   a) retrieving data related to said educational content, said data being retrieved from said first database, said data including said voice data for playback to said user;
   b) presenting said educational content to said user using said voice data and at least one avatar within a predetermined presentation time;
   c) selecting a question from a plurality of questions relating to said educational content;
   d) resetting a timer for timing a user response to an examination question, said examination question being related to said educational content;
   e) presenting said question to said user;
   f) receiving a response from said user to said question;
   g) determining if said timer has expired;
   h) in the event said timer has expired, determining that said response is incorrect;
   i) in the event said timer has not expired, determining if said response is a correct response;
   j) adjusting a score for said user based on whether said response is correct or incorrect;
   k) repeating steps c) to j) for a predetermined number of times until predetermined number of questions have been responded to by said user;
      wherein said computer executable instructions are for downloading and installation on a user computing device; and
      said predetermined presentation time is less than 15 minutes.

In a second aspect, the present invention provides a method for delivering said educational content to users, the method comprising:
a) retrieving and installing a software module from a server, said software module being for installation on a user computing device;
b) retrieving, by way of a computer network, data related to said educational content, said data being retrieved from said a first database, said data including said voice data for playback to said user;
c) presenting said educational content to said user using said voice data and at least one avatar within a predetermined presentation time;
   said predetermined presentation time is less than 15 minutes.

In a third aspect, the present invention provides computer-readable media having encoded thereon computer-readable and computer-executable instructions which, when executed by a processor, implements a method for delivering said educational content to users, the method comprising:
a) retrieving and installing a software module from a server, said software module being for installation on a user computing device;
b) retrieving, by way of a computer network, data related to said educational content, said data being retrieved from said a first database, said data including said voice data for playback to said user;
c) presenting said educational content to said user using said voice data and at least one avatar within a predetermined presentation time;
   said predetermined presentation time is less than 15 minutes.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the invention; and

FIG. 2 is a flowchart detailing the steps in a method according to another aspect of the invention.

### DETAILED DESCRIPTION OF THE INVENTION

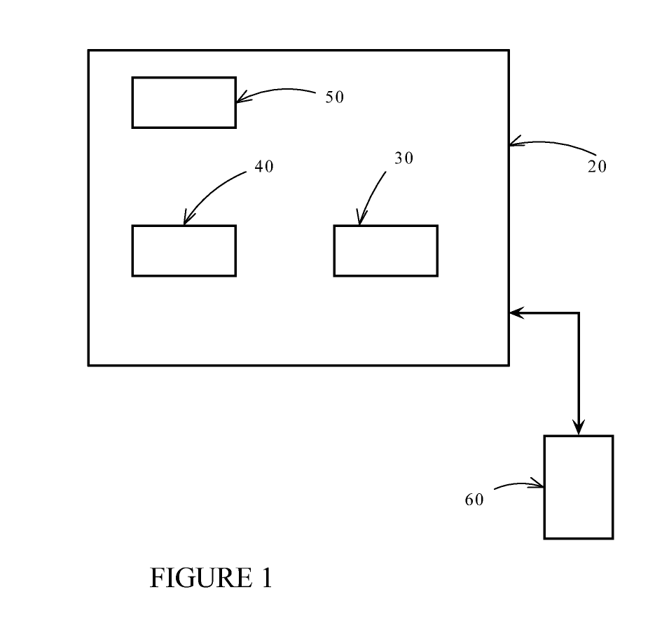

Referring to FIG. 1, a block diagram of a system according to one aspect of the invention is illustrated. The system 10 has a server 20, on which resides a first database 30 and a second database 40. Also resident on the server 20 is a software module 50 which is downloadable and installable on a user device 60.

The software module 50 is downloadable on to the user device 60 and is also installable on the device 60. Once installed, the software module 50 becomes an executable application on the device 60. In the vernacular, the software module 50 is installed as an application or “app” on the device 60.

After installation on the user device 60, the software module 50 communicates with the first database 30 and second database 40. The first database 30 contains data relating to educational material for specific subjects in at least one structured educational course. The data in the first database 30 may include voice data and text data, as well as data for animations, slide shows, and/or presentations. The second database 40 contains data relating to users including user profiles as well as profiles and configuration settings for the software module 50.

In operation, the software module 50 initially communicates with the second database 40 to register the user on the database. Once registered, the user will be provided with a suitable user profile which will track the user's progress and performance through the various educational courses available. The software module 50 will periodically communicate with the second database to update the user's profile with respect to examinations taken by the user, courses completed by the user, and the user's performance on the examinations already completed.

To present educational material to the user, the software module 50 installed on the user device 60 communicates with the first database 30 to download the relevant educational material. For a specific course on a specific subject matter, the software module 50 downloads and installs all the relevant data to the device 60. Thus, once the educational material has been downloaded and installed on the device, the software module 50 can present the educational material for a specific course to the user without the need for a connection to the first database 30. It should be noted that downloading the relevant data for a specific course includes downloading the text and visual data for the educational material, voice data for presenting the course to the user, as well as any other supporting data or code which may be needed to present a specific course to the user.

Within the first database 30, data may be compartmentalized so that data for a specific course is segregated from data for other courses. Thus, as an example, for the subject matter of aircraft safety, various courses, each relating to fatigue with each course highlighting different key concepts regarding fatigue and aircraft safety, may be available for download to the user device 60. The data for each course may be segregated from one another and may be separately downloadable to the user device.

Regarding the user device 60, the device may take the form of any computing device capable of communicating with the server by way of wired or wireless network means. As examples, the user device 60 may be a tablet, a smartphone, a laptop, a desktop, or any other similarly suited device. The device 60 may communicate with the server through a wired Internet connection, a wireless network connection, or any other suitable network connection.

The educational materials relating to the course may be delivered to the user using animations, text, video, and voice recordings. To ensure a more personal and lively interaction between the software module and the user, avatars with corresponding voice recordings may be used to present concepts, scenarios, and ideas to the user. As noted above, when the software module downloads the data associated with a specific course, the data includes the sound or voice data as well as any animation or code required to properly present the educational material to the user. When delivering the educational content to the user, the software module may, if appropriate, present the user with further clarification or a subject at hand. As an example, if a concept is being introduced to a user, the software module may give the user the option to view or access more than one example which illustrates the concept.

The educational materials should be so designed such that a whole course can be viewed and digested by a user in under 10-15 minutes. Thus, the course can be designed to highlight only a few key points on the subject so that a user can easily understand and digest the educational materials. In one implementation, each course can take as little time as 5-7 minutes with a series of courses being used to properly cover some topics. A user who has a few minutes to spare can therefore take a course within that limited time span. Instead of requiring multiple uninterrupted hours to learn the material for a specific subject, a user can learn the material in smaller, easily digestible and understandable chunks by completing multiple courses, the cumulative effect of these courses which is the same as completing a much larger and more comprehensive course on the subject matter in one sitting. A series of these courses may be distributed over time such that a user would automatically receive multiple courses over a given amount of time. The distributed learning approach also facilitates improved knowledge retention. It should be noted that, once the educational material for a course has been presented to the user, the user can be considered to have completed that course. Repeated presentations of the same material to a user, the equivalent of reviewing a past course, are, of course, possible.

It should be noted that the various courses which may be downloaded by the software module may all be associated with one specific field or subject. As well, these various courses may be cumulative in that they need to be completed in a specific sequence as later courses build on the knowledge and material from the earlier courses. Of course, the courses may also be independent of each other and, as such, do not need to be taken in sequence.

For an implementation involving courses which need to be taken in sequence, the courses may be spaced out to allow the user some time to digest the material. As an example, if there are 5 courses for a specific subject, the user may only be allowed to download and execute a limited number of software modules that subject per day (e.g. a limit of only downloading 3 courses on the same subject per day). This way, a user will not be able to download, execute, and complete a large number of courses per day. The user is thus prevented from rushing through the courses and thereby risk completing the courses without having time to digest and potentially retain the material.

It should be noted that courses may be grouped together into a course group. A course group would be a group of courses relating to a specific subject matter. As an example, different course groups for aircraft safety may include course groups on fatigue, threat and error management, decision making, situation awareness, workload management, and communication. Each of these course groups would be composed of anywhere from 15-30 different courses on the subject. As an example, the course group on the subject of fatigue and aircraft safety would have 20 different courses, each covering a different topic on the subject and each one highlighting at least one key concept on the subject. Completing a course group (i.e. successfully completing all courses in the course group by viewing and interacting with all the courses in a course group and successfully passing a course group examination) may, depending on the configuration of the courses, render a user eligible for a certificate of completion, a professional certification, or a professional rating. For some course groups, courses may need to be taken in sequence as some material may build on concepts and skills highlighted or covered in previous courses.

The amount of time used by a user on a specific course group can also be tracked. A timer is started as soon as user begins a course. The amount of time the user spends on each course in a course group counts toward total training time a user spends on that course group. This timer is paused when the execution of the software module is suspended, as what happens when the software module is relegated to the background of the computing device. In one implementation, the maximum training time that may be credited to a user is 10 minutes per active course session. If the user exits the course and re-enters the course, the user is allowed to accumulate more training time for the same course. For example, if a user tapped on the same course 3 times, once for 10 minutes and the other 2 times for 5 minutes each, then the user would get a credit of 20 minutes of training time for that course. The user would thus receive a credit of 20 minutes of training time for whichever course group the course belongs to.

When a user's accumulated training time for a specific course group reaches a milestone, the user may be awarded with a training time badge at the end of the course. In one implementation involving aircraft safety, training time milestones are defined as 15 minutes for a bronze star award, 30 minutes for a silver star award and, for every 30 minutes after that, gold stars are awarded up to a maximum training time of 5 hours. If a user reaches a milestone during a course, a training time badge is displayed after the course summary page.

Once the educational materials for all the courses in a course group have been presented to the user, the user will then be provided with the opportunity to take a course group examination which assesses the user's grasp and retention of the educational material for the particular course group. In one implementation, the examination will need to be taken and passed before the user can be given credit for the course group. As such, the examination may be considered to be part of the educational materials and indeed to be a necessary component of the course group. The examination questions can be randomly selected from a number of possible questions which relate to the educational materials presented during the presentation of the courses.

For the testing phase of the course, a number of questions and their answers are prepared for each course group and these questions and their corresponding correct answers may be downloaded to the user device as part of the final course for the course group. The course group questions form part of the data downloaded to the user device for each course group. When the user has completed the course group, he or she is then queried as to whether they are ready to take the test. If they are ready and the questions have been downloaded to the user device, a question is randomly selected from the number of questions previously prepared. The question is presented to the user and, when the user is ready, a response is entered on the user device. The correctness of the response is then assessed against the predetermined correct response. The process then repeats a predetermined number of times, with each question being selected from the number of questions stored on the user device. The user's overall performance in the examination is then made note of and the user's profile on the server is updated. The user should be given limitations on the examination. As an example, instead of waiting until the user enters a response to a question, a timer can be used to allot a specific time frame for receiving a response from the user. If, after the timer has expired and the user has not yet entered a response, the user may be considered to have entered an incorrect response. In one implementation, the user is given only 30 seconds to complete each question. It should also be noted that, to prevent users from second-guessing themselves, after a user has entered a response to a question, he or she cannot go back to previously answered questions.

The examination itself may take the form of multiple choice questions. Alternatively, some questions may be fill-in-the-blank type questions.

To pass the examination on the course group, the user has to correctly answer a predetermined number of questions provided. This number of correct answers may vary from course group to course group and may be reconfigurable as the circumstances dictate. In the event the user has not passed the examination, the user may retake the examination at a later date with a different set of questions from the same group of predetermined questions for the course group. To prevent users from simply retaking the examination over and over within a given time frame, an examination for a course group may be prevented from being presented to the user if an insufficient amount of time has passed since the last examination for the same course group. As an example, if a user takes and fails an examination for a specific course group, the same examination (albeit with different questions) will not be allowed to be presented to the user until after 24 hours has passed.

Regarding the server illustrated in FIG. 1, the databases illustrated as being inside the server may not necessarily be resident on the same server. Multiple servers may be used to provide the database services described above. As well, the software module used in the invention may be downloaded from different servers and not necessarily only from the servers housing the databases.

The various aspects of the invention may be incorporated in an integrated system including a website and a predetermined skills training regimen. The various downloadable courses may be part of a post-classroom training regimen. After an in-classroom training session, the various courses can be downloaded by the participants to reinforce and encourage retention of the material.

The courses may be used for professional pre-training by presenting a series of instruction to students before their arrival at a training centre. This step can diagnose the level of knowledge and skill of the individual learner. This step can also bring their knowledge and skill up to a standardized level. Such a step can also allow for the reduction of face-to-face time at the training centre. Following classroom time at the training centre, the courses accessible through the various aspects of the invention can again be used to facilitate learning after learners have left the classroom and have returned to their workplace. Within this stage of training, learners will complete courses at regular intervals throughout the year (perhaps once or twice a week). The goal of this training is to facilitate retention of knowledge, skill, and attitude and to continue to enhance skills beyond what was accomplished in the training centre.

As noted above, a user's progress is tracked and saved by way of a user profile on the server. The user profile can tracks several user parameters, including the user's name, organization, gender, age, courses assigned, progress in courses, courses completed, and a logbook of the user's activities. The logbook provides complete user details associated with the user's progress through a predetermined curriculum. The logbook can also provide a ‘skill meter’ that compares their progress to a set standard. Badges and other award indicia may be given to users for key achievements (such as courses completed, time spent in training, reaching competency-milestones, etc.) and these awards may be tracked by way of the logbook. As an option, a user's achievements may be shared through various social media portals.

To facilitate a user's access to his or her progress, a website or Internet-accessible portal may be provided. A registered user can thus login to the portal and access his or her profile online. By doing so, the user can see his or her progress, including a listing of courses completed, courses registered for, awards gained, achievements awarded, and skills gained. Where applicable, the portal can also provide access to accreditations earned, relevant extra or external material for further research and/or study, as well as access to other users for discussion groups and feedback.

While a user may access the portal by way of a web browser, the software module may also be configured to provide access to the portal's resources whenever an Internet connection is available to the module. The software module can also provide access to a discussion forum where users of the service can post messages and discuss matters of common interest. This discussion forum may take a form similar to an online bulletin board system. Different discussion forums may be set up such that different subject matter and discussions are segregated from one another. As an example, a discussion forum for those taking courses relating to aircraft safety would be separate and segregated from a discussion forum for those taking courses related to aircraft maintenance. The various discussion groups can provide a means for various users to share and discuss experiences relating to the various course subject matters. Each discussion forum will be established securely and can be unique to a particular organization or to a particular group or subject matter. The discussion groups will allow users to share stories, ask questions of administrators, view related videos, see average progress for users within their group and anonymously compare their individual progress. As well, the discussion groups will allow them to read about examples which apply what they have learned in the courses to their real-world environment.

It should be noted that the services provided may be accessed at a corporate level. A corporate entity may thus register all of its employees for a specific set of courses. Each employee would thus be able to access these courses. The corporate entity can therefore provide skills enhancement training to its employees without losing valuable employee productivity as the training would be spread out over time instead of the more traditional classroom-based training which necessitates employee down-time.

For such a corporate implementation, a specific discussion forum for that company's employees may be implemented. As well, corporate administrators may be granted access to the user profiles of the company's employees. Employee progress through the various courses and curricula can thus be monitored and, where necessary, applauded by the company. Administrative functions for such corporate accounts can also be implemented by way of the web portal.

For the corporate implementation where a company registers multiple employees for different training courses, a company-specific portal may be implemented. From the company administrator portal, companies that are using the platform to train their employees would be able to manage users, review user progress, push notifications, and manage settings.

For user management, company administrators would be able to add new users or register new users for courses through individual email addresses or through a file containing email addresses. When new users are added or registered, they can be automatically sent an email with a company-entitlement code. Users can then bind their profile, created on the website, to a company through this code. Similarly, company administrators can, through the portal, manage users, including the deletion and modification of corporate users and the assigning of courses for specific corporate users.

Using the corporate portal, company administrators would also be able to add/remove administrators as well as set-up billing options for the company.

The corporate portal can also provide corporate account administrators to send custom push notifications through the system to its registered corporate users. Users who are identified with the company and who have installed the software module their mobile device will receive the push notification through their device. Other users identified with the company and who do not have a mobile device on file will receive the push notification as an email. Within the company portal, corporate administrators can access a push composer which allows company administrators to create custom-push notifications. Through the company portal, administrators can send messages or push notifications to all registered employees or to just a subset of registered employees. To allow for such a capability, the user database tracks registered user device identification and presents company administrators with corporate user names to allow administrators to select specific employees. For ease of re-use and access, the corporate portal retains previously designed push notices and these are available to be reused.

Corporate administrators can also access a rich push composer by way of the corporate portal. Using this composer, push content can include quizzes, videos, and pictures. Quizzes created using the push composer can be designed to allow for multiple attempts and/or be time limited. Also, push content can be designed which allow system administrators to send push notifications to users within a specific geographic area. Finally, use of the rich push composer allows administrators to generate a variety of reports allowing for the tracking of aspects of how and when people access push notifications

The corporate portal also allows corporate administrators to review progress by user or by company. Company administrators can sort users based on: user first name, user last name, user email, number of courses completed, course groupings completed, average level of achievement (for all courses completed), view details (listing per course group), course group name, courses completed in each course group, date of completion for each course group, total training time in each course group, number of examination attempts, examination scores, user's rating of course/course group quality (out of 5.0), and course/course group learning experience (out of 5.0). The course learning experience would be a user's feedback rating on the quality of the course and/or course group.

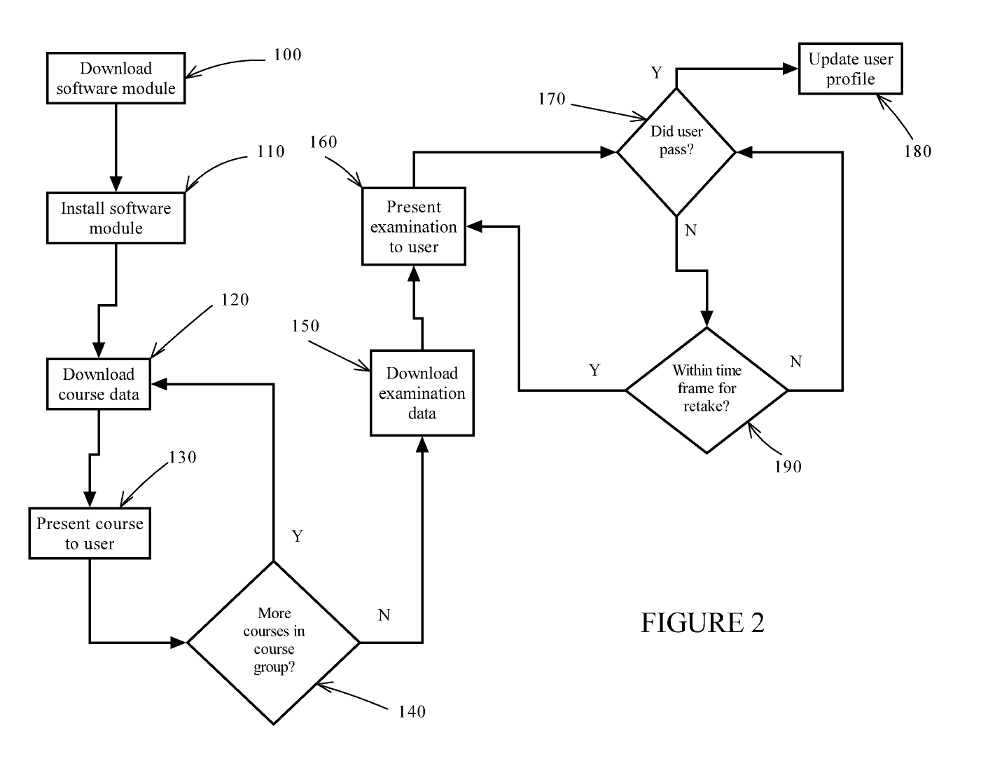

Referring to FIG. 2, a flowchart detailing the steps in a method according to one aspect of the invention is illustrated. The method begins at step 100, that of the user downloading the software module to their computing device. Once downloaded, the software module is then installed on the computing device (step 110). Step 120 is that of the software module downloading the complete data required to present a course to the user. The educational content for the course is then presented to the user (step 130). Decision 140 then checks if there are more courses available for the specific course group. If other courses are needed for the course group, the logic flow then moves back to step 120. If there are no more courses for the specific course group, the relevant examination data for the course group is downloaded on to the user computing device (step 150). The examination is then presented to the user (step 160). After the user completes the examination, decision 170 assesses whether the user has passed the examination. If the user has passed the examination, then the user's profile is updated with this achievement (step 180). If the user has not passed the examination, decision 190 then checks if a retaking of the examination is allowable (i.e. within a preset time frame). As noted above, the user may not be allowed to retake the examination within a given time frame (e.g. 24 hours). If the retaking of the examination is within the time frame, the logic flow then moves back to step 160.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g.“C”) or an object oriented language (e.g.“C++”). Alternative embodiments of the invention may be implemented as pre-programmed hardware elements, other related components, or as a combination of hardware and software components. Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A system for providing educational content to students, the system comprising:
a first database containing data relating to said education content, said data including voice data;
a second database containing user information;
computer readable media having encoded thereon computer readable and computer executable instructions which, when executed by a processor, implements a method for delivering said educational content to users, the method comprising:
a) retrieving data related to said educational content, said data being retrieved from said first database, said data including said voice data for playback to said user;
b) presenting said educational content to said user using said voice data and at least one avatar within a predetermined presentation time;
c) selecting a question from a plurality of questions relating to said educational content;
d) resetting a timer for timing a user response to an examination question, said examination question being related to said educational content;
e) presenting said question to said user;
f) receiving a response from said user to said question;
g) determining if said timer has expired;
h) in the event said timer has expired, determining that said response is incorrect;
i) in the event said timer has not expired, determining if said response is a correct response;
j) adjusting a score for said user based on whether said response is correct or incorrect;
k) repeating steps c to j for a predetermined number of times until predetermined number of questions have been responded to by said user;
wherein said computer executable instructions are for downloading and installation on a user computing device; and
said predetermined presentation time is less than 15 minutes.

2. A system according to claim 1 wherein steps c) to k) are executed after educational content relating to a plurality of courses have been presented to said user.

3. A system according to claim 1 wherein said score for said user is uploaded to said second database after step k) has been executed.

4. A system according to claim 3 wherein said score is used to update a user profile for said user on said second database.

5. A system according to claim 1 wherein said user computing device is at least one of: a tablet computing device, a smartphone, a mobile computing device, and a computer.

6. A system according to claim 2 wherein step a) further comprises downloading all data required to present at least one of said plurality of courses to said user.

7. A system according to claim 1 wherein said computer readable and computer executable instructions are contained in a software module on a server.

8. A system according to claim 1 wherein said educational content relates to aviation training.

9. A system according to claim 4 wherein said user profile is accessible to said user by way of a website.

10. A system according to claim 8 wherein said educational content relates to aircraft safety.

11. A system according to claim 1 wherein said data in said first database includes at least one of: text, animation, video, and images.

12. A system according to claim 1 wherein said predetermined presentation time is between 5-7 minutes.

13. A method for delivering said educational content to users, the method comprising:
a) retrieving and installing a software module from a server, said software module being for installation on a user computing device;
b) retrieving, by way of a computer network, data related to said educational content, said data being retrieved from said a first database, said data including said voice data for playback to said user;
c) presenting said educational content to said user using said voice data and at least one avatar within a predetermined presentation time;
said predetermined presentation time is less than 15 minutes.

14. A method according to claim 13 further including the steps of:
d) selecting a question from a plurality of questions relating to said educational content;
e) resetting a timer for timing a user response to an examination question, said examination question being related to said educational content;
f) presenting said question to said user;
g) receiving a response from said user to said question;
h) determining if said timer has expired;
i) in the event said timer has expired, determining that said response is incorrect;
j) in the event said timer has not expired, determining if said response is a correct response;
k) adjusting a score for said user based on whether said response is correct or incorrect;
l) repeating steps d to k for a predetermined number of times until a predetermined number of questions have been responded to by said user

15. A method according to claim 14 further including the step of updating said user's profile in a second database with said score.

16. A method according to claim 14 wherein steps d) to l) are executed only after educational content relating to a plurality of courses have been presented to said user.

17. A method according to claim 13 wherein said educational content relates to aircraft safety.

18. A method according to claim 15 wherein said user profile is accessible to said user by way of a website.

19. A method according to claim 16 wherein said plurality of courses comprises at least one series of courses which cover a single topic.

20. Computer-readable media having encoded thereon computer-readable and computer-executable instructions which, when executed by a processor, implements a method for delivering said educational content to users, the method comprising:
a) retrieving and installing a software module from a server, said software module being for installation on a user computing device;
b) retrieving, by way of a computer network, data related to said educational content, said data being retrieved from said a first database, said data including said voice data for playback to said user;
c) presenting said educational content to said user using said voice data and at least one avatar within a predetermined presentation time;
said predetermined presentation time is less than 15 minutes.
